(19) United States
(12) Patent Application Publication
(10) Pub. No.: US 2026/0163107 A1
(43) Pub. Date: Jun. 11, 2026

(54) BATTERY

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 19/300,946

(22) Filed: Aug. 15, 2025

(30) Foreign Application Priority Data
Dec. 6, 2024 (JP) 2024-214015

(51) Int. Cl. H01M 10/654; H01M 10/0585; H01M 10/613; H01M 10/653; H01M 10/6551; H01M 50/103; H01M 50/474; H01M 50/486

(52) U.S. Cl. CPC H01M 10/654; H01M 10/0585; H01M 10/613; H01M 10/653; H01M 10/6551; H01M 50/103; H01M 50/474; H01M 50/486

(57) ABSTRACT

A battery of the present disclosure includes an electrode laminate having a hexahedral shape, an exterior can that seals the electrode laminate, and a heat spreader that is in contact with at least four surfaces of the exterior can and the electrode laminate. The heat spreader is configured of a heat spreading sheet.

### CROSS-REFERENCE TO RELATED APPLICATION

This application claims priority to Japanese Patent Application No. 2024-214015 filed on Dec. 6, 2024. The disclosure of the above-identified application, including the specification, drawings, and claims, is incorporated by reference herein in its entirety.

### BACKGROUND

### 1. Technical Field

The present disclosure relates to a battery.

### 2. Description of Related Art

As a lithium ion secondary battery having excellent safety, a solid-state battery is known.

Japanese Patent No. 7136708 (JP 7136708 B) discloses an all-solid-state battery cell (hereinafter, also referred to as a “battery”). In the battery, an electrode laminate is enclosed in an exterior material. The electrode laminate includes a current collection tab that extends from an end portion thereof. The current collection tab is connected to a terminal derived from an end portion of the battery. A first heat transfer material is disposed inside the exterior material to be in contact with the electrode laminate and the exterior material. A heat dissipation member is disposed to cover an end surface of the electrode laminate in a lamination direction of the electrode laminate.

### SUMMARY

An electrode laminate usually generates heat by charging or discharging. In a case where the heat dissipation of the electrode laminate is not easily performed, there is a possibility that a malfunction (for example, shortening of the life of the battery) occurs. Therefore, a battery in which heat is efficiently conducted between an exterior can and the electrode laminate and that has an excellent structural efficiency is desired. The “structural efficiency” indicates a ratio of a volume of a power generation element included in the battery to a volume of the battery.

The present disclosure has been made in view of the above-described circumstances. A problem to be solved by an embodiment of the present disclosure is to provide a battery in which heat is efficiently conducted between an exterior can and an electrode laminate and that has an excellent structural efficiency.

The means for solving the above problem includes the following aspects.

A battery according to a first aspect includes

an electrode laminate having a hexahedral shape,
an exterior can configured to enclose the electrode laminate, and
a heat spreader that is in contact with the exterior can and at least four surfaces of the electrode laminate.
The heat spreader is made of a heat spreading sheet.

The “heat spreading sheet” refers to a sheet having a thermal conductivity in a planar direction of 100 W/mK or more. The thermal conductivity of the heat spreading sheet in the planar direction may be 2000 W/mK or less. The heat spreading sheet may be a self-standing sheet. The heat spreading sheet does not include a sheet containing resin (hereinafter, also referred to as a “heat conductive sheet”) (for example, a sheet formed of resin, and a sheet containing resin and a thermally conductive filler).

In the first aspect, the battery includes the heat spreader that is in contact with the exterior can and at least the four surfaces of the electrode laminate. The heat spreader is made of the heat spreading sheet. The heat spreading sheet has a high thermal conductivity even though the heat spreading sheet has the thickness smaller than the thickness of the heat conductive sheet. As a result, the battery according to the first aspect is a battery in which heat is efficiently conducted between the exterior can and the electrode laminate and that has an excellent structural efficiency.

A battery according to a second aspect is

the battery according to the first aspect, in which the heat spreader surrounds the four surfaces of the electrode laminate.

In the battery according to the second aspect, heat is more efficiently conducted between the exterior can and the electrode laminate than in a case where the heat spreader does not surround the four surfaces of the electrode laminate.

A battery according to a third aspect is

the battery according to the first or second aspect, in which
a thickness of a part of the heat spreader facing a laminate end surface of the electrode laminate is larger than a thickness of a part of the heat spreader facing a laminate surface of the electrode laminate,
the electrode laminate includes a first current collector, a first active material layer, a solid electrolyte layer, a second active material layer, and a second current collector in an order of the first current collector, the first active material layer, the solid electrolyte layer, the second active material layer, and the second current collector along a lamination direction,
the laminate end surface includes an end surface of the first current collector, an end surface of the first active material layer, an end surface of the solid electrolyte layer, an end surface of the second active material layer, and an end surface of the second current collector, and the laminate surface includes a surface of the electrode laminate in the lamination direction.

By charging or discharging, the laminated end surface of the electrode laminate tends to generate heat more than the laminated surface. In the battery according to the third aspect, the heat of the electrode laminate that is generated by charging or discharging can be efficiently transferred by the exterior can. As a result, in the battery according to the third aspect, heat is more efficiently conducted between the exterior can and the electrode laminate.

A battery according to a fourth aspect is

the battery according to any one of the first to third aspects, in which
the heat spreading sheet includes a heat spreading layer and an electrical insulation layer provided on at least one main surface of the heat spreading layer,
the heat spreading layer includes at least one of a graphite sheet, aluminum foil, and copper foil, and
the heat spreading sheet is disposed such that the electrical insulation layer is on a side of the electrode laminate.

In the battery according to the fourth aspect, the occurrence of a short circuit in the electrode laminate is more reliably reduced.

A battery according to a fifth aspect is

the battery according to any one of the first to third aspects, in which
the heat spreading sheet is made of solely a heat spreading layer,
the heat spreading layer includes at least one of a graphite sheet, aluminum foil, and copper foil,
an electrical insulation resin body is interposed between a laminate end surface of the electrode laminate and the heat spreader,
the electrode laminate includes a first current collector, a first active material layer, a solid electrolyte layer, a second active material layer, and a second current collector in an order of the first current collector, the first active material layer, the solid electrolyte layer, the second active material layer, and the second current collector along a lamination direction, and
the laminate end surface includes an end surface of the first current collector, an end surface of the first active material layer, an end surface of the solid electrolyte layer, an end surface of the second active material layer, and an end surface of the second current collector.

In the fifth aspect, the thickness of the heat spreading sheet is smaller than the thickness of the heat spreading sheet including the electrical insulation layer. That is, the thickness of the battery according to the fifth aspect in the lamination direction can be further reduced. As a result, in the battery according to the fifth aspect, the occurrence of the short circuit in the electrode laminate is more reliably reduced, and the volume efficiency of the battery is more excellent.

According to the present disclosure, a battery in which heat is efficiently conducted between an exterior can and an electrode laminate and that has an excellent structural efficiency is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery according to a first embodiment of the present disclosure;

FIG. 2 is a sectional view taken along line II-II of FIG. 1;

FIG. 3 is a cross-sectional view of a battery according to a second embodiment of the present disclosure;

FIG. 4 is a cross-sectional view of a battery according to a third embodiment of the present disclosure;

FIG. 5 is a cross-sectional view of a battery according to a fourth embodiment of the present disclosure; and

FIG. 6 is a cross-sectional view of a battery according to a fifth embodiment of the present disclosure.

### DETAILED DESCRIPTION OF EMBODIMENTS

In the numerical ranges described stepwise in the present disclosure, an upper limit value or a lower limit value described in a certain numerical range may be replaced with an upper limit value or a lower limit value of another stepwise-described numerical range.

Hereinafter, embodiments of the battery of the present disclosure will be described with reference to the drawings. In the drawings, the same or corresponding parts are denoted by the same reference numerals, and the description thereof will not be repeated.

### (1) First Embodiment

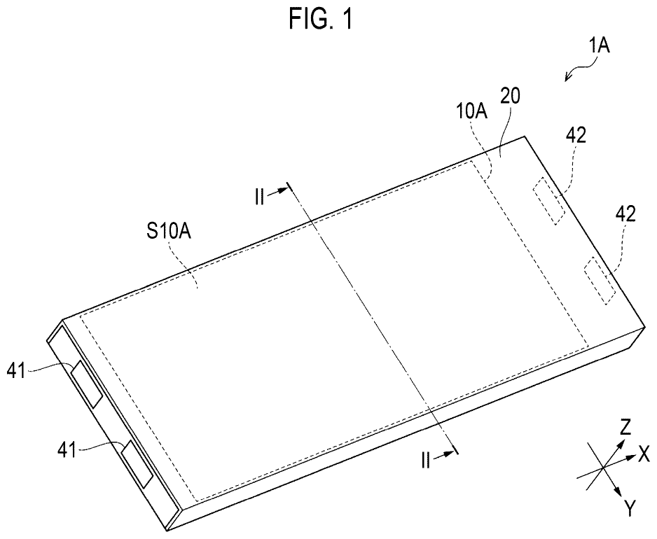

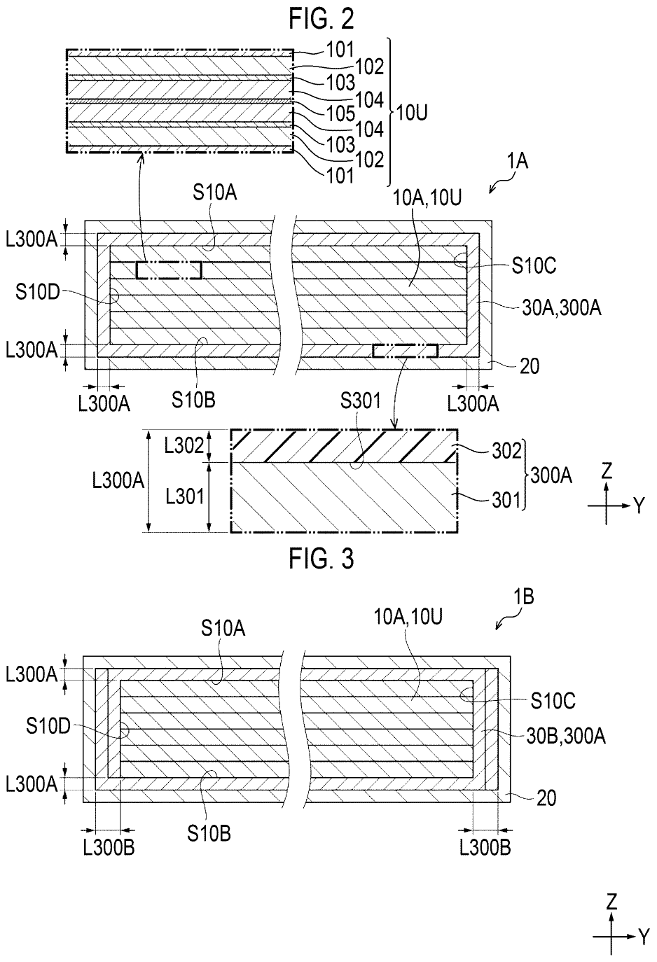

The battery 1A of the first embodiment is a solid-state battery. As shown in FIG. 1, the battery 1A includes an electrode laminate 10A, an exterior can 20, a heat spreader 30A (see FIG. 2), two positive electrode terminals 41, and two negative electrode terminals 42. The electrode laminate 10A is a rectangular parallelepiped (an example of a hexahedral shape).

In the first embodiment, a longitudinal direction of the laminate surface S10A that is the main surface of the electrode laminate 10A is defined as an X-axis direction. A short-hand direction of the laminate surface S10A of the electrode laminate 10A is defined as a Y-axis direction. A thickness direction of the electrode laminate 10A is defined as a Z-axis direction (an example of the lamination direction). Each of the X-axis, the Y-axis, and the Z-axis is orthogonal to each other. The X-axis direction is an example of the axial direction. The directions of the electrodes are not limited to the directions during use of the battery of the present disclosure.

The two positive electrode terminals 41, the electrode laminate 10A, and the two negative electrode terminals 42 are disposed in this order along the X-axis positive direction. The two positive electrode terminals 41 and the two negative electrode terminals 42 are electrically connected to the electrode laminate 10A. The heat spreader 30A is in contact with four surfaces of the exterior can 20 and the electrode laminate 10A (that is, the laminate surfaces S10A, S10B and the laminate end surfaces S10C, S10D), and surrounds the four surfaces of the electrode laminate 10A. The exterior can 20 encloses the electrode laminate 10A.

### (1.1) Electrode Laminate

The electrode laminate 10A functions as a power generation element of the battery 1A. The electrode laminate 10A includes a plurality of unit electrode bodies 10U. A plurality of unit electrode bodies 10U are stacked along the Z-axis direction. A plurality of unit electrode bodies 10U are connected in parallel.

The unit electrode body 10U has a monopolar structure. The unit electrode body 10U is constituted by laminating the positive electrode current collector 101, the positive electrode active material layer 102, the solid electrolyte layer 103, the negative electrode active material layer 104, the negative electrode current collector 105, the negative electrode active material layer 104, the solid electrolyte layer 103, the positive electrode active material layer 102, and the positive electrode current collector 101 in this order along the Z-axis direction.

The positive electrode current collector 101 collects current of the positive electrode active material layer 102. Examples of the material of the positive electrode current collector include stainless steel, aluminum, copper, nickel, iron, titanium, carbon, and aluminum alloy. The positive electrode current collector 101 has a shape of, for example, a foil shape or a mesh shape.

The positive electrode active material layer 102 may further contain at least one of a solid electrolyte, a conductive material, and a binder as needed.

As the positive electrode active material, it is preferable to contain a lithium composite oxide. Examples of the lithium composite oxide include a rock salt layered active material, a spinel type active material, and an olivine type active material. The positive electrode active material may be a known positive electrode active material.
Examples of the solid electrolyte include a sulfide solid electrolyte, an oxide solid electrolyte, a nitride solid electrolyte, and a halide solid electrolyte. The solid electrolyte may be a known solid electrolyte.
Examples of the conductive material include a carbon material, metal particles, and a conductive polymer. Examples of the carbon material include acetylene black and carbon fibers.
Examples of the binder include a vinyl halide resin (for example, polyvinylidene fluoride) and a rubber (for example, acrylate butadiene rubber).

The solid electrolyte layer 103 may further contain a binder as needed. The solid electrolyte and the binder are the same as those exemplified as the solid electrolyte and the binder that can be included in the positive electrode active material layer 102.

The negative electrode active material layer 104 contains a negative electrode active material and may further contain at least one of a solid electrolyte, a conductive material, and a binder as needed.

Examples of the negative electrode active material include a Li-based active material (for example, metallic lithium), a carbon-based active material (for example, graphite), an oxide-based active material (for example, lithium titanate), and a Si-based active material (for example, Si).
The solid electrolyte, the conductive material, and the binder are the same as those described as the solid electrolyte, the conductive material, and the binder that can be included in the positive electrode active material layer 102.

The negative electrode current collector 105 collects current of the negative electrode active material layer 104. Examples of the material of the negative electrode current collector include stainless steel, aluminum, copper, nickel, iron, titanium, carbon, and an aluminum alloy. The shape of the negative electrode current collector 105 is, for example, a foil shape or a mesh shape.

The electrode laminate 10A is a rectangular parallelepiped. As shown in FIG. 2, the electrode laminate 10A has a laminate surface S10A, S10B, laminate end surfaces S10C, S10D, and a pair of laminate end surfaces (not shown). The laminate surfaces S10A, S10B face each other in the Z-axis direction. The laminate end surfaces S10C, S10D face each other in the Y-axis direction. A pair of laminate end surfaces (not shown) face each other in the X-axis direction.

In the first embodiment, the laminate surfaces S10A, S10B are constituted by the positive electrode current collector 101. The laminate end surfaces S10C, S10D are constituted by the end surfaces of the respective layers constituting the unit electrode body 10U. That is, the laminate end surfaces S10C, S10D include the end surfaces of the positive electrode current collector 101, the end surfaces of the positive electrode active material layer 102, the end surfaces of the solid electrolyte layer 103, the end surfaces of the negative electrode active material layer 104, and the end surfaces of the negative electrode current collector 105. In the laminate end surfaces S10C, S10D, the end surfaces of the respective layers constituting the unit electrode body 10U are on the same plane by batch cutting.

### (1.2) Exterior Can

The exterior can 20 is a metal container. The exterior can 20 may have an electrically insulating film on an inner wall facing the electrode laminate 10A. The exterior can 20 may be a known exterior can.

### (1.3) Heat Spreader

The heat spreader 30A efficiently conducts heat between the exterior can 20 and the electrode laminate 10A. In addition, in the first embodiment, the heat spreader 30A electrically insulates the electrode laminate 10A and the exterior can 20 from each other. The heat spreader 30A is in physical contact with the exterior can 20 and the electrode laminate 10A.

The heat spreader 30A is configured of a heat spreading sheet 300A. In the first embodiment, the heat spreader 30A is formed by winding the heat spreading sheet 300A around the four surfaces of the electrode laminate 10A once.

As shown in FIG. 2, the heat spreading sheet 300A has a heat spreading layer 301 and an electrical insulation layer 302 provided on one main surface S301 of the heat spreading layer 301. The heat spreading sheet 300A is disposed such that the electrical insulation layer 302 is on the electrode laminate 10A side.

The heat spreading layer 301 includes at least one of a graphite sheet, aluminum foil, and copper foil. The heat spreading layer 301 may be a single layer or may be a multi-layer. Examples of the material of the electrical insulation layer 302 include a resin and ceramics. The electrical insulation layer 302 may have adhesiveness or bondability. A thickness L300 (refer to FIG. 2) of the heat spreading sheet 300A may be appropriately selected according to the material of the heat spreading sheet 300A, and may be 10 μm to 1000 μm, and may be 10 μm to 400 μm. A thickness L301 (see FIG. 2) of the heat spreading layer 301 may be thicker than a thickness L302 (see FIG. 2) of the electrical insulation layer 302 or may be thinner than the thickness L302. The thickness L301 of the heat spreading layer 301 may be 10 μm to 700 μm, may be 10 μm to 300 μm, and may be 10 μm to 50 μm. The heat spreading sheet 300A may be a known heat spreading sheet. From the viewpoint of further improving the volume efficiency, the heat spreading layer 301 preferably includes a graphite sheet having a relatively thin thickness (for example, 10 μm to 50 μm).

### (1.4) Negative Electrode Terminal and Positive Electrode Terminal

The positive electrode terminal 41 and the negative electrode terminal 42 are used to lead the electricity generated in the electrode laminate 10A to the outside of the battery 1A. The positive electrode terminal 41 and the negative electrode terminal 42 may be known terminals.

### (1.5) Action Effect

As described with reference to FIGS. 1 and 2, the battery 1A includes the electrode laminate 10A, the exterior can 20, and the heat spreader 30A. The heat spreader 30A is configured of a heat spreading sheet 300A.

The heat spreading sheet 300A has a high thermal conductivity even though the heat spreading sheet 300A is thinner than the thickness of the heat conductive sheet. As a result, the battery 1A is a battery in which heat is efficiently conducted between the exterior can 20 and the electrode laminate 10A and which has an excellent structural efficiency.

As described with reference to FIGS. 1 and 2, the battery 1A is such that the heat spreader 30A surrounds the four surfaces of the electrode laminate 10A.

In the battery 1A, heat is more efficiently conducted between the exterior can 20 and the electrode laminate 10A when the heat spreader 30A does not surround the four surfaces of the electrode laminate 10A.

As described with reference to FIGS. 1 and 2, in the battery 1A, the heat spreading sheet 300A includes the heat spreading layer 301 and the electrical insulation layer 302. The heat spreading layer 301 includes at least one of a graphite sheet, aluminum foil, and copper foil. The heat spreading sheet 300A is disposed such that the electrical insulation layer 302 is on the electrode laminate 10A side.

In the battery 1A, the occurrence of a short circuit of the electrode laminate 10A is more reliably prevented.

### (2) Second Embodiment

The battery 1B according to the second embodiment is the same as the battery 1A except that the thickness of the heat spreader is different.

The battery 1B includes the electrode laminate 10A, the exterior can 20, a heat spreader 30B (see FIG. 3), two positive electrode terminals 41, and two negative electrode terminals 42.

As shown in FIG. 3, the heat spreader 30B is configured of a heat spreading sheet 300A. In the second embodiment, the heat spreader 30B is formed by partially winding the heat spreading sheet 300A twice around the four surfaces of the electrode laminate 10A. A thickness L300B (see FIG. 3) of a portion of the heat spreader 30B that faces the laminate end surfaces S10C, S10D of the electrode laminate 10A is thicker than a thickness L300A (see FIG. 3) of a portion of the heat spreader 30B that faces the laminate surfaces S10A, S10B of the electrode laminate 10A. The thickness L300B is, for example, a thickness that is twice the thickness L300A.

### (2.1) Action Effect

The battery 1B is the same as the battery 1A except that the heat spreader 30A is changed to the heat spreader 30B. Therefore, the battery 1B has the same effects as the battery 1A.

As described with reference to FIG. 3, the thickness L300B of the portion of the heat spreader 30B facing the laminate end surfaces S10C, S10D of the electrode laminate 10A is thicker than the thickness L300B of the portion of the heat spreader 30B facing the laminate surfaces S10A, S10B of the electrode laminate 10A.

The laminate end surfaces S10C, S10D of the electrode laminate 10A are more likely to generate heat than the laminate surfaces S10A, S10B by charging or discharging. In the battery 1B, the heat of the electrode laminate 10A generated by charging or discharging can be efficiently transferred by the exterior can 20. As a result, in the battery 1B, heat is more efficiently conducted between the exterior can 20 and the electrode laminate 10A.

### (3) Third Embodiment

The battery 1C according to the third embodiment is the same as the battery 1A except that the heat spreading sheet is different and the electrically insulating resin body is provided.

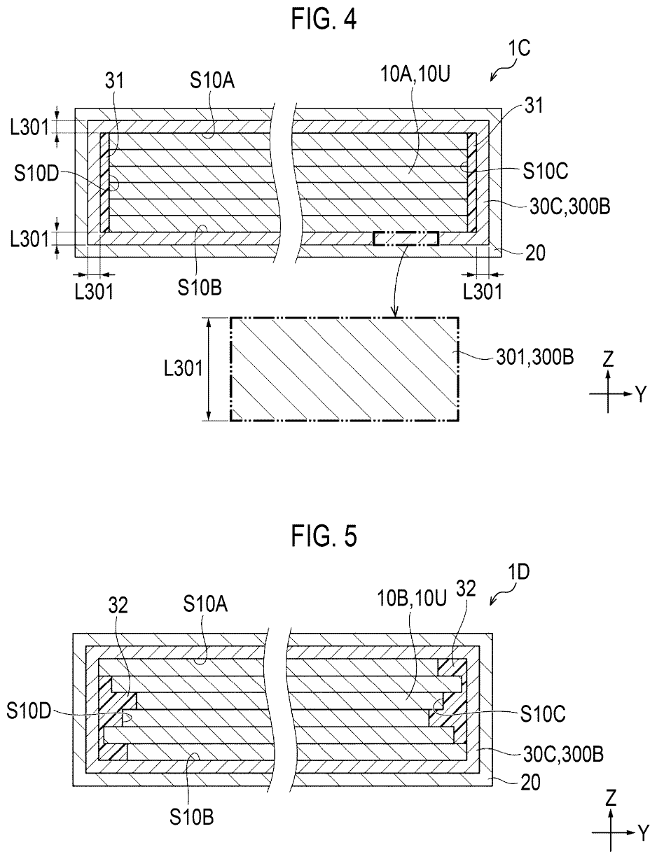

The battery 1C includes the electrode laminate 10A, the exterior can 20, the heat spreader 30C, an electrically insulating resin body 31 (see FIG. 4), two positive electrode terminals 41, and two negative electrode terminals 42. The electrically insulating resin body 31 is interposed between the laminate end surfaces S10C, S10D of the electrode laminate 10A and the heat spreader 30C.

### (3.1) Heat Spreader

The heat spreader 30C is configured of a heat spreading sheet 300B. In the third embodiment, the heat spreader 30C is formed by winding the heat spreading sheet 300B around the four surfaces of the electrode laminate 10A once. As shown in FIG. 4, the heat spreading sheet 300B is formed of solely the heat spreading layer 301.

### (3.2) Electrically Insulating Resin Body

The electrically insulating resin body 31 prevents the short circuit (for example, short circuit between the positive electrode active material layer 102 and the negative electrode active material layer 104) of the electrode laminate 10A. The electrically insulating resin body 31 contains a known resin (thermoplastic resin, thermosetting resin, or the like). The thermoplastic resin may be an elastomer. The electrically insulating resin body 31 may contain a thermal conduction filler from the viewpoint of more efficiently performing thermal conduction between the exterior can 20 and the electrode laminate 10A. Examples of the material of the thermally conductive filler include a metal oxide (for example, alumina, silica, and magnesia), a metal nitride (for example, aluminum nitride, silicon nitride, and boron nitride), artificial diamond, and silicon carbide. The electrically insulating resin body 31 may be a film-like processed product (that is, a self-standing film) or a molded body of a paste.

### (3.3) Action Effect

The battery 1C is the same as the battery 1A except that the heat spreader 30A is changed to the heat spreader 30C and the electrically insulating resin body 31 is provided. Therefore, the battery 1C has the same effects as the battery 1A.

As described with reference to FIG. 4, in the battery 1C, the heat spreading sheet 300B is formed of solely the heat spreading layer 301. The heat spreading layer 301 includes at least one of a graphite sheet, aluminum foil, and copper foil. The electrically insulating resin body 31 is interposed between the laminate end surfaces S10C, S10D of the electrode laminate 10A and the heat spreader 30C.

A thickness L301 of the heat spreading sheet 300B is thinner than a thickness L300A of the heat spreading sheet 300A including the electrical insulation layer 302. That is, the thickness of the battery 1C in the Z-axis direction (that is, the lamination direction) can be made thinner. As a result, in the battery 1C, the occurrence of a short circuit of the electrode laminate 10A is more reliably prevented, and the volume efficiency of the battery 1C is more excellent.

### (4) Fourth Embodiment

The battery 1D according to the fourth embodiment is the same as the battery 1A except that the heat spreading sheets are different from each other and the electrically insulating resin body is provided.

The battery 1D includes the electrode laminate 10B, the exterior can 20, the heat spreader 30C, the electrically insulating resin body 32 (see FIG. 5), two positive electrode terminals 41, and two negative electrode terminals 42. The electrically insulating resin body 32 is interposed between the laminate end surfaces S10C, S10D of the electrode laminate 10B and the heat spreader 30C.

### (4.1) Electrode Laminate

As shown in FIG. 5, the electrode laminate 10B is the same as the electrode laminate 10A except that the end surfaces of the respective layers constituting the unit electrode body 10U are not on the same plane at the laminate end surfaces S10C, S10D.

### (4.2) Electrically Insulating Resin Body

The electrically insulating resin body 32 prevents the short circuit (for example, short circuit between the positive electrode active material layer 102 and the negative electrode active material layer 104) of the electrode laminate 10B. The electrically insulating resin body 32 may be the same as the electrically insulating resin body 31. The electrically insulating resin body 32 may be a molded body of a paste.

### (4.3) Action Effect

The battery 1D is the same as the battery 1C except that the electrode laminate 10A is changed to the electrode laminate 10B and the electrically insulating resin body 31 is provided instead of the electrically insulating resin body 31. Therefore, the battery 1D has the same effects as the battery 1C.

As described with reference to FIG. 5, in the battery 1D, the electrically insulating resin body 32 is interposed between the laminate end surfaces S10C, S10D of the electrode laminate 10B and the heat spreader 30C. As a result, a gap is less likely to be formed between the electrode laminate 10B and the heat spreader 30C. As a result, in the battery 1D, heat is more efficiently conducted between the exterior can 20 and the electrode laminate 10B than in a case where a gap is formed between the electrode laminate 10B and the heat spreader 30C.

### (5) Fifth Embodiment

The battery 1E according to the fifth embodiment is the same as the battery 1A except that the electrically insulating resin body is provided.

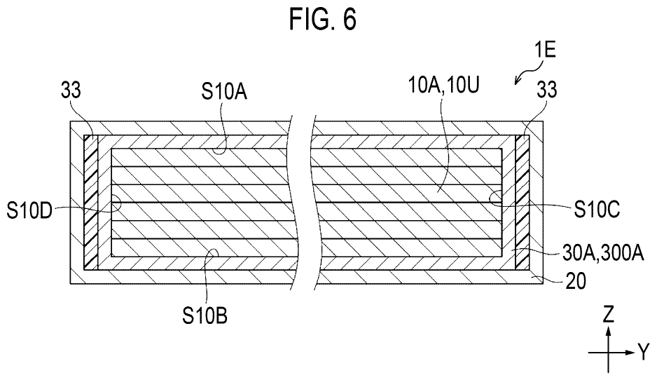

The battery 1E includes the electrode laminate 10A, the exterior can 20, the heat spreader 30A, an electrically insulating resin body 33 (see FIG. 6), two positive electrode terminals 41, and two negative electrode terminals 42. The electrically insulating resin body 33 is interposed between the part of the heat spreader 30A facing the laminate end surfaces S10C, S10D and the exterior can 20.

### (5.1) Electrically Insulating Resin Body

The electrically insulating resin body 33 reliably prevents the electrical connection between the electrode laminate 10A and the exterior can 20. The electrically insulating resin body 33 may be the same as the electrically insulating resin body 31. The electrically insulating resin body 31 may be a film-like processed product (that is, a self-standing film) or a molded body of a paste.

### (5.2) Action Effect

The battery 1E is the same as the battery 1A except that the electrically insulating resin body 33 is provided instead of the electrically insulating resin body 31. Therefore, the battery 1E has the same effects as the battery 1A.

As described with reference to FIG. 6, in the battery 1E, the electrically insulating resin body 33 is interposed between the part of the heat spreader 30A facing the laminate end surfaces S10C, S10D and the exterior can 20. As a result, a gap is less likely to be formed between the heat spreader 30A and the exterior can 20. As a result, in the battery 1E, heat is more efficiently conducted between the exterior can 20 and the electrode laminate 10A than in a case where a gap is formed between the heat spreader 30A and the exterior can 20.

### (6) Modification

In the batteries 1A to 1E, the heat spreaders 30A, 30B, 30C surround the four surfaces of the electrode laminate 10A, 10B, but the present disclosure is not limited thereto. In the present disclosure, the heat spreader 3 may not surround the four surfaces of the electrode laminate.

In the batteries 1A to 1E, the heat spreading layer 301 includes at least one of a graphite sheet, aluminum foil, and copper foil, but the present disclosure is not limited thereto. In the present disclosure, as long as the thermal conductivity of the heat spreading sheet in the planar direction is 100 W/mK or more, the heat spreading layer may not include at least one of a graphite sheet, aluminum foil, and copper foil.

In the batteries 1A to 1E, the electrode laminate 10A, 10B is a rectangular parallelepiped, but the present disclosure is not limited thereto. In the present disclosure, the electrode laminate may be a cuboid.

In the batteries 1A to 1E, the carrier ions of the electrode laminate 10A, 10B are lithium ions, but the present disclosure is not limited thereto. In the present disclosure, the carrier ions of the electrode laminate may be sodium ions.

What is claimed is:

1. A battery comprising:
an electrode laminate having a hexahedral shape;
an exterior can configured to enclose the electrode laminate; and
a heat spreader that is in contact with the exterior can and at least four surfaces of the electrode laminate, wherein the heat spreader is made of a heat spreading sheet.

2. The battery according to claim 1, wherein the heat spreader surrounds the four surfaces of the electrode laminate.

3. The battery according to claim 1, wherein:
a thickness of a part of the heat spreader facing a laminate end surface of the electrode laminate is larger than a thickness of a part of the heat spreader facing a laminate surface of the electrode laminate;
the electrode laminate includes a first current collector, a first active material layer, a solid electrolyte layer, a second active material layer, and a second current collector in an order of the first current collector, the first active material layer, the solid electrolyte layer, the second active material layer, and the second current collector along a lamination direction;
the laminate end surface includes an end surface of the first current collector, an end surface of the first active material layer, an end surface of the solid electrolyte layer, an end surface of the second active material layer, and an end surface of the second current collector; and
the laminate surface includes a surface of the electrode laminate in the lamination direction.

4. The battery according to claim 1, wherein:
the heat spreading sheet includes a heat spreading layer and an electrical insulation layer provided on at least one main surface of the heat spreading layer;
the heat spreading layer includes at least one of a graphite sheet, aluminum foil, and copper foil; and
the heat spreading sheet is disposed such that the electrical insulation layer is on a side of the electrode laminate.

5. The battery according to claim 1, wherein:
the heat spreading sheet is made of solely a heat spreading layer;
the heat spreading layer includes at least one of a graphite sheet, aluminum foil, and copper foil;
an electrical insulation resin body is interposed between a laminate end surface of the electrode laminate and the heat spreader;
the electrode laminate includes a first current collector, a first active material layer, a solid electrolyte layer, a second active material layer, and a second current collector in an order of the first current collector, the first active material layer, the solid electrolyte layer, the second active material layer, and the second current collector along a lamination direction; and
the laminate end surface includes an end surface of the first current collector, an end surface of the first active material layer, an end surface of the solid electrolyte layer, an end surface of the second active material layer, and an end surface of the second current collector.
